(19) United States
(12) Patent Application Publication
(10) Pub. No.: US 2012/0188136 A1
(43) Pub. Date: Jul. 26, 2012

(54) RADIOFREQUENCY ANTENNA WITH MULTIPLE RADIATING ELEMENTS FOR TRANSMITTING A WAVE WITH A VARIABLE DIRECTION OF PROPAGATION

(75) Inventors: Jean-Pierre Brasile, Colombes (FR); Friedman Tchoffo Talom, Colombes (FR); Patrick Sirot, Colombes (FR); Dominque Fasse, Colombes (FR)

(73) Assignee: THALES, Neuilly Sur Seine (FR)

(21) Appl. No.: 13/335,451

(22) Filed: Dec. 22, 2011

(30) Foreign Application Priority Data
Dec. 27, 2010 (FR) 1005125

(51) Int. Cl. H01Q 3/32

(52) U.S. Cl. 343/758

(57) ABSTRACT

The invention relates to a radiofrequency antenna comprising a chassis (26) and an emission surface supporting a set of radiating antenna elements, each radiating in a unique emission direction, characterized in that each antenna element is at least partially movable relative to the emission surface to modify its specific emission direction and in that it comprises means for moving the antenna elements in a coordinated manner along said surface to form, from the elementary waves produced by the antenna elements, a coherent wave propagating in a direction that is angularly offset relative to the normal to the emission surface.

### CROSS-REFERENCE TO RELATED APPLICATIONS

This patent application claims priority to French patent application no. FR1005125, filed Dec. 27, 2010, the disclosure of which is herein incorporated by reference in its entirety.

### BACKGROUND

The present invention relates to a radiofrequency antenna, of the type comprising a chassis and an emission surface supporting a set of radiating antenna elements, each radiating in a unique emission direction.

Array antennas with helical transmitting elements are known, in particular from U.S. Pat. No. 6,115,005. Likewise, this type of compact antenna is capable of transmitting very high peaking capacities, as for example described in the document by Li, X. Q.; Liu, Q. X.; Zhang, J. Q.; Zhao, L.; Zhang, Z. Q.; , “The high-power radial line helical circular array antenna: Theory and development,” Microwave and Millimeter Wave Technology (ICMMT), 2010, International Conference on , vol., No., pp.671-674, 8-11 May 2010, doi: 10.1109/ICMMT.2010.5525020. However, the possibilities for aiming such a very high-power antenna remain limited due to the direct connection, generally in a vacuum, between the power source and the antenna. Generally, a radial line helical circular array antenna is made up of a radial transmission line, which can be powered through its center or its periphery, and an array of regularly distributed radiating antenna elements. Each antenna element comprises a helical radiating wire protruding on the emitting face. The wire is connected to a pickup loop present within the radial transmission line of the antenna, on the other side of the emission surface. Each of the helical radiating wires is positioned with an initial angle so as to form, for example, a coherent electromagnetic field whereof the direction of propagation is perpendicular to the emission surface.

The angle of departure for the helices of each antenna element is set for good so that the phase shift between the different antenna elements allows the coherent addition in the desired emission direction.

In order to change the emission direction of the antenna, it is known to mount the antenna on an articulated and motorized support making it possible to move the entire antenna, in particular its emission surface and all of the antenna elements present, as well as the support chassis of the emission surface.

The electromagnetic radiation source used to power the very high-power antenna is generally made up of a relativistic source (high-power magnetron, magnetically insulated line oscillator (MILO), backward-wave oscillator, relativistic klystron, for example). The source, connection guide, antenna assembly must then be kept in a vacuum and is very difficult to deform, due to the breakdown risks limiting the technologies and architectures making it possible to aim the antenna in a particular direction, other than by moving the assembly.

### SUMMARY

The invention aims to propose a radiofrequency antenna that can be used in an arrangement where the direction of the field radiated by the antenna is angularly mobile in one or two directions, without requiring complex deformable guide elements or the movement of substantial masses.

To that end, the invention relates to a radiofrequency antenna of the aforementioned type, characterized in that each antenna element is at least partially movable relative to the emission surface to modify its specific emission direction and in that it includes means for moving the antenna elements in a coordinated manner along said surface to form, from the elementary waves produced by the antenna elements, a coherent wave propagating in a direction that is angularly offset relative to the normal to the emission surface.

According to specific embodiments, the radiofrequency antenna comprises one or more of the following features:

the antenna elements are distributed by groups of antenna elements, the elements of a same group being present in a strip of the emission surface extending perpendicular to the projection of the emission direction on the surface, the antenna elements of a same group being positioned to produce elementary waves having a same phase shift relative to the waves produced by the antenna elements of another group,

the means for moving the antenna elements can position the antenna elements so that they each produce an elementary wave phase shifted by a phase shift [symbol] φ relative to the other antenna elements defined by:

[symbol]

φ=2πh tgθ/λ

where θ is the incline angle of the emission direction relative to the normal to the emission surface, λ is the wavelength of the electromagnetic radiation, and h is the distance of the antenna element from a reference axis measured along the emission direction on the emission surface,

the antenna elements each include an emission wire rotatably mounted relative to the emission surface and the means for moving the antenna elements are capable of rotating the antenna elements,

the movement means include racks mounted slidingly relative to the emission surface and the emission wires are integral with driving pinions engaged with the racks, and in that the movement means include a mechanism for synchronized movement of the racks,

the synchronized movement mechanism includes a rotary control crown relative to the chassis and provided with control cams of the racks, the racks each being equipped with at least one cam follower cooperating with a cam, and a motor for rotating the crown,

the antenna elements comprise a deformable emission wire, and in that the movement means comprise a mechanism designed to ensure the deformation of each emission wire to modify the specific emission direction,

the antenna elements each comprise a focusing lens for the elementary electromagnetic wave produced by the antenna element, and in that the movement means comprise an angular movement mechanism for each focusing lens,

the emission surface supporting the radiating antenna elements is rotary relative to the chassis, and in that it comprises means for rotating the emission surface,

the chassis delimits a closed vacuum space in which the antenna elements are contained, and in that it comprises force-reacting guide pins between the chassis and the emission surface.

### BRIEF DESCRIPTION OF THE DRAWINGS

The invention will be better understood upon reading the following description, provided solely as an example and done in reference to the appended drawings, in which:

FIG. 1 is a cross-sectional view of an antenna according to the invention, in top view, along line I-I of FIG. 2;

FIG. 2 is a transverse cross-sectional view of the antenna according to the invention along line II-II of FIG. 1;

FIG. 3 is a detailed cross-sectional view of an antenna element of the antenna according to the invention; and

FIGS. 4, 5 and 6 are elevation views of alternative embodiments of antenna elements according to the invention.

### DETAILED DESCRIPTION

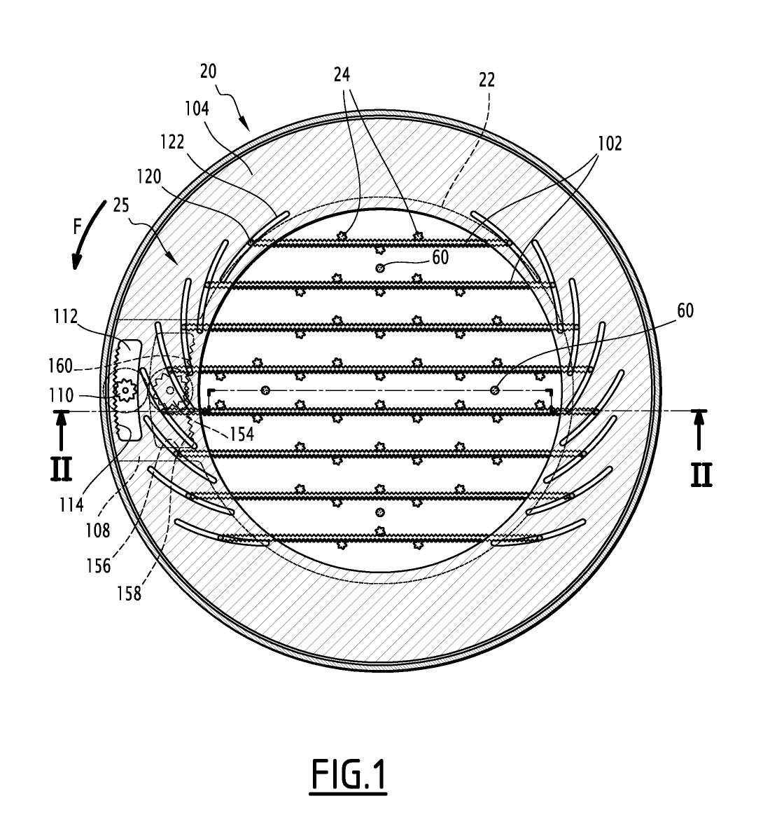

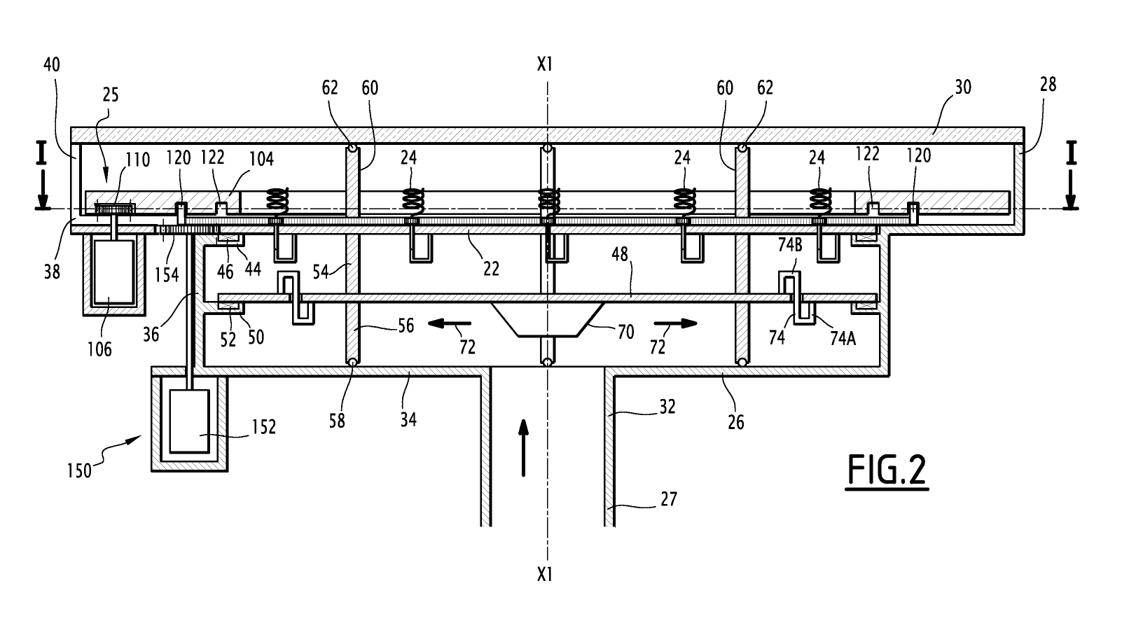

The antenna 20 according to the invention is shown in top view and cross-section in FIG. 1 and in transverse cross-section in FIG. 2. It assumes the general shape of a disk with axis X1-X1. According to the invention, each antenna 20 is capable of emitting in a direction T-T angularly offset by an angle θ relative to the axis X1-X1 of the antenna.

Its planar emission surface is formed by a circular plate 22 rotatably mobile around the axis X1-X1 and on which a set of radiating antenna elements 24 regularly distributed on the surface of the plate 22 is positioned. The antenna elements are each able to produce an elementary wave, each along a unique emission direction and with a unique phase shift such that the addition of the elementary waves produces a coherent wave in direction T-T.

These antenna elements each have an axis X2-X2 normally perpendicular to the plate 22.

According to the invention, the antenna is equipped with means 25 for moving the antenna elements relative to the emission surface to modify their emission direction and/or their phase. In the embodiment described here, the means 25 are capable of producing a rotational movement around themselves of all or part of the antenna elements.

The plate 22 is supported by a chassis 26 in the general shape of a bell gradually flaring from an inlet 27 for collecting the magnetic radiation coming from the source 12 to an outlet mouth 28 for the radiation coming from the antenna elements 24. This mouth is covered by an airtight protective wall 30 making it possible to create the vacuum inside the chassis 26. The wall 30 is transparent to the electromagnetic radiation and forms a radome.

The inlet end 27 of the chassis 26 is formed by a tube extended by a crown 34 forming the bottom of the chassis. This crown has axis X1-X1. The bottom is extended by a first peripheral wall 36 having, at its end turned toward the mouth 28, a divergent shoulder 38 forming a support. This shoulder is bordered by a second peripheral wall 40 supporting the protective wall 30.

The plate 22 bears on an inner peripheral rim 44 of the side wall 34. This rim 44 forms a bearing for guiding the rotation of the plate 22 around the axis X1-X1. To that end, it is advantageously equipped with a ball bearing 46.

Positioned between the plate 22 and the bottom 34 is an intermediate separating wall 48 extending parallel to the plate 22 and separating the annular space delimited by the side wall 36 into two adjacent spaces. The wall 44 is supported, like the plate 22, by a rim forming a bearing 50 advantageously equipped with a ball bearing 52.

Connecting and force-reacting guide pins 54 are positioned between the plate 22 and the wall 48. They extend parallel to the axis X1-X1 and are equidistributed along one or more circles of axis X1-X1 on the surface of the plate so as to ensure the mechanical strength of the assembly when the antenna is in vacuum. These guide pins rigidly connect the plate 22 and the wall 48.

Guide pins 56 extending the guide pins 44 extend between the wall 48 and the bottom 34 in the extension of the guide pins 54. The guide pins 56 are connected to the wall 48 at one of their ends and have a sliding contact 58 at their other ends bearing on the surface of the bottom 34.

Likewise, guide pins 60 extend the guide pins 54 from the plate 22 to the protective wall 30. These guide pins are fixed to the plate 22 and bear along a sliding contact 62 on the wall 30.

The sliding bearing of the guide pins 52 and 60 on the bottom 34 and the wall 30 is for example ensured by positioning a freely rotating ball at the end of each guide pin.

The intermediate wall 48 supports, opposite the conduit 32, along axis X1-X1, a metal cone 70 able to modify the propagation mode of the electromagnetic flow, going from a TM01 mode flow along the axis X1-X1 to a TEM mode centripetal flow extending from the axis X1-X1 outward in the direction of the arrows 72.

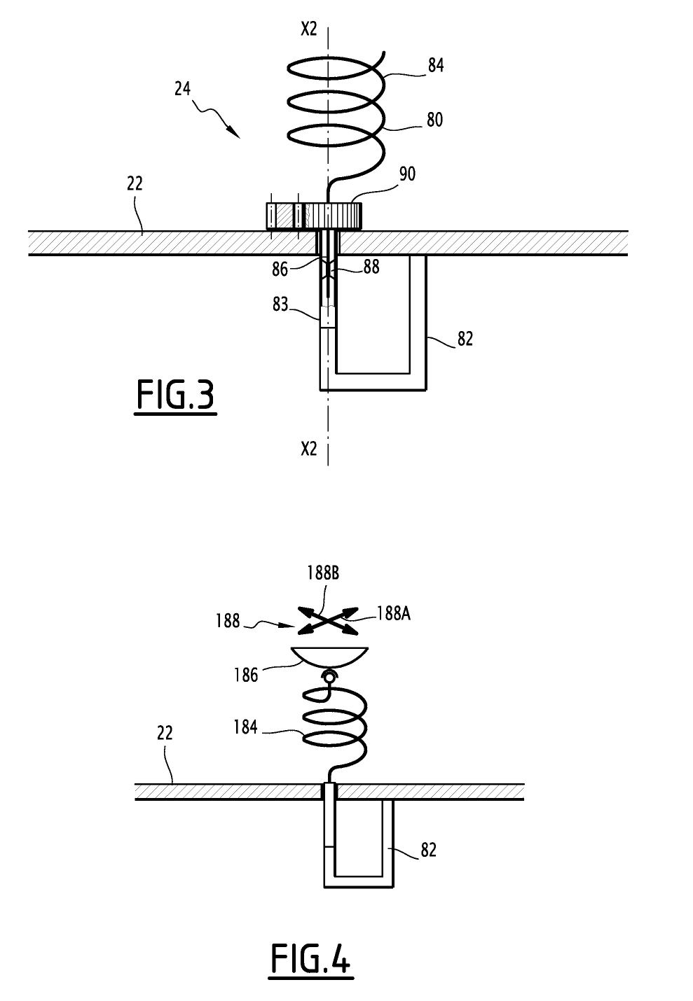

The intermediate wall 48 is provided with traversing loops 74 regularly distributed along a circle centered on axis X1-X1. These loops 74 are formed by a metal conductor closed on itself and have two lobes 74A, 74B protruding on either side of the intermediate wall 48. The antenna elements 24 are shown on a larger scale in FIG. 3. According to the invention, these antenna elements are capable of turning on themselves around their axis X2-X2 parallel to the axis X1-X1.

FIG. 3 shows the plate 22 supporting the antenna element 24. Each antenna element comprises an emission wire 80 positioned on the antenna emission loop side and a pickup loop 82 positioned between the panel 22 and the intermediate wall 48.

The loop 82 is rigidly and fixedly connected to the wall 22 by one of its ends while remaining electrically isolated from the wall 22 in its crossing toward the emission wire 84. The loop has a shape known in itself and is obtained by curving a metal conductor on itself.

The wire 80 has an emission part 84 made up of a solid metal wire in the shape of a helix. This wire is extended by a core 86 engaged inside the hollow conductor forming the loop 82 while ensuring an electrical connection.

A sliding contact 88 is ensured between the conductor 83 and the core 86 using any adapted type of arrangement thereby allowing the emission wire 80 to rotate relative to the loop 82 while ensuring an electrical connection.

A drive pinion 90 is positioned around the wire 80 at the connection between the helical emission part 84 and the core 86. This pinion extends perpendicular to the axis X2-X2 of rotation of the emission wire and is positioned along the panel 22 on the emission mouth 28 side. It is integral in rotation with the wire 80.

As illustrated in FIG. 1, the mechanism 25 for rotating the antenna elements 24 around themselves includes a set of racks 102 positioned parallel to one another on the surface of the plate 22 turned toward the mouth 28. These racks thus extend along chords of the disk forming the plate 22. They are perpendicular to the component of direction T-T along the emission plane defined by the plate 22.

These racks have, on either side, rectilinear toothings engaged with the pinions 90 of the adjacent antenna elements. In this way, the antenna elements associated with a same rack are alternately distributed on either side of the rack.

The racks 102 are mounted to be slidingly mobile along the surface of the plate 22. They are maintained laterally by the antenna elements positioned on either side.

The drive mechanism 25 also comprises a crown 104 for controlling the racks and a motor 106 for driving the control crown 104.

The crown 104 bears on the shoulder 38 and is laterally guided by the peripheral wall 40. The crown has axis X1-X1. It is angularly movable relative to the plate 22 around its axis along an angular travel in the vicinity of 60°.

The motor 106 is fixed to an extension of the plate 22 denoted 108. The extension extends to the outside of the closed space delimited by the chassis 26 and the protective wall 30. The output shaft of the motor is equipped with a pinion 110 received in a groove 112 of the crown 104. This groove is in the shape of an arc of circle centered on the axis X1-X1 and has, on a cylindrical surface, a toothing 114 engaged with the pinion 110 to drive the crown under the action of the motor 106.

Each rack 102 extends in the space delimited between the shoulder 38 and the crown 104. At both of its ends, each rack has a driving finger 120 received in a groove 122 forming a cam of the control crown 104.

The grooves 122 forming a cam have a curved shape and have a width equal to the thickness of the driving finger 120. They generally extend along an angular opening around the crown 104 equal to the angular travel of the crown 104 relative to the plate 22.

The grooves 122 are symmetrical to one another for a same rack relative to a diameter of the disk forming the plate, this diameter extending perpendicular to the racks 102.

The profile of the grooves forming a cam 122 is such that, for a given rack situated at a distance R-h from the center of the plate 22, R being the radius of the plate, the movement of the rack is such that it produces an angular movement of the antenna element 24 meshed with it equal to [symbol] φ according to the formula:

[symbol]

φ=2πh tgθ/λ (1)

where θ is the incline angle relative to the normal to the emission direction T-T of the antenna and λ is the wavelength of the electromagnetic radiation to be emitted. In general, the incline of the grooves forming the cam 22 increases from one side denoted A to the other side of the crown in the direction of the arrow F as shown in FIG. 1.

The antenna elements are thus distributed by group while being associated with a same rack. All of the antenna elements of a same group are thus situated in a strip extending in the plane of the plate 22 perpendicular to the emission direction T-T. These antenna elements are all able to be moved by a same angular offset when the associated rack is moved. The initial angular offset of the helices is calculated to allow the coherent addition in the main axis of the antenna for centered positioning of that rack to allow travel of the beam on either side of said axis. One alternative, only conducive to travel by a single side, would correspond to an initial adjustment of the helices to allow the coherent addition along the main axis for abutting positioning of the racks.

The antenna lastly comprises a mechanism 150 globally rotating the plate 22 and the set of antenna elements around the axis X1-X1 relative to the chassis 26. This mechanism comprises a motor 152 supported by the chassis 26. It has, on its output shaft, a pinion 154 capable of driving the plate 22. To that end, the plate 22 has, in the extension 108, a semi-circular slot 156 centered on the axis X1-X1 whereof one wall 158 has a toothing 160 engaged with the pinion 154.

During operation, in such an antenna, the electromagnetic flow arriving along axis X1-X1 through the inlet 27 is distributed along the surface of the intermediate wall 28 by the mode converter 70.

The then-centripetal flow is picked up by the lobes 74A of the loops and re-emitted by the lobes 74B in the space between the plate 22 and the intermediate wall 48. The loops 82 of the antenna elements 24 again pick up the electromagnetic wave, inducing a current up to the emission wire 84, which re-emits the electromagnetic wave in a direction and with a phase that are specific to the angular positioning of the antenna elements.

When the crown 104 is in an extreme position, all of the antenna elements are oriented in the same direction, so that they produce elementary electromagnetic waves with zero relative phase shifts.

When, under the action of the motor 106, the control crown 104 is moved angularly, the racks 102 are moved parallel to one another while being driven by both of their ends by the drive fingers stressed by a wall of the grooves 122 forming a cam.

The amplitude of the movement applied to each rack is defined by the shape of the groove forming a cam 122 present at each end so that the further the rack is from the point A, the greater the amplitude of its movement.

When the racks are moved, the associated antenna elements are angularly moved, the rack driving the pinion 90 integral with the emission wire 80. Under these conditions, it will be understood that all of the emission wires associated with a same rack and belonging to the same group are moved angularly by the same amplitude, thus producing a phase shift between the elementary electromagnetic waves emitted by those antenna elements and those of the antenna elements associated with other racks that undergo a different movement.

It will be understood, due to formula (1), that the phase shifts applied to the antenna elements are such that according to their position, the antenna elements produce an electromagnetic wave whereof the phase shift corresponds to the phase shift existing between the wave actually emitted and the wave that would have been emitted by antenna elements situated in a plane angularly offset by an angle θ relative to the plane of the plate 22. Thus, the electromagnetic wave resulting from the elementary waves produced by the elements is coherent, the elementary waves being in phase in a plane perpendicular to the propagation direction T-T and that coherent antenna wave propagating in direction T-T is angularly offset by an angle θ relative to the normal to the plate 22.

It will be understood that such an arrangement makes it possible to modify the direction of propagation of the wave by an angle θ that depends on the position of the control crown 104, which is controlled by the motor 106. Upon a 360° rotation of the crown 104, the direction of propagation T-T describes a cone of revolution along axis X1-X1 and with half-cone angle θ. The angle θ is adjustable independently of the overall movement and thus makes it possible to achieve two-dimensional aiming over a solid angle with half-cone angle θmax (θmax being the angle during maximum travel of the racks).

Likewise, the motor 152, through action on the plate 22 through the pinion 154 meshed with the toothing 158, enables an overall movement of all of the antenna elements with a same angular offset around their axis X2-X2 by moving the plate 22, thereby making it possible to phase shift all of the antenna elements and therefore the antenna. This phase shifter can operate over a wide frequency range and at very high powers.

The antenna thus formed therefore makes it possible, without an articulated element in the wave inlet guide conduit, to emit an angularly offset wave.

This angular offset is obtained without it being necessary to move the chassis of the antenna and its randome angularly.

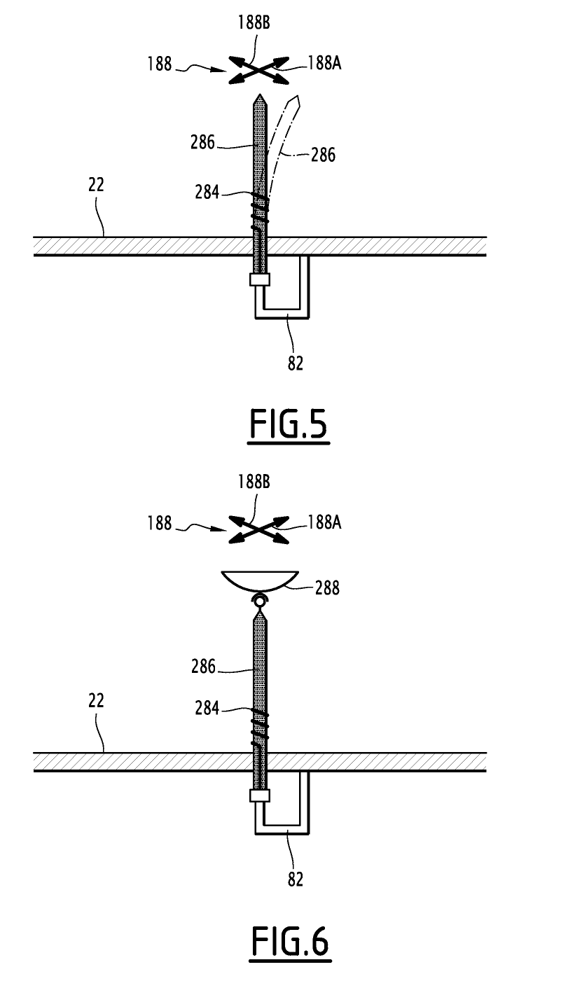

According to one alternative embodiment, illustrated in light of FIG. 4, each antenna element 24 is formed by a radiating wire 184 fixedly mounted in rotation relative to the panel 22. All of the wires are identical and are oriented identically. Each wire is associated with a focusing lens 186 positioned at the corresponding wire. This lens can focus the electromagnetic wave produced by the wire.

These lenses are associated with a mechanism 188 for angularly moving each lens 186 around two axes 188A, 188B extending perpendicular to one another and parallel to the plate 22. The mechanism 188 is such that all of the lenses have a same orientation, thereby allowing a deviation by an angle θ of all of the elementary electromagnetic waves initially emitted normally to the plate 22 by each of the wires 184.

One can see that with such an arrangement, the coherent wave produced by the addition of the elementary electromagnetic waves produced by each antenna element propagates along a predefined angle θ relative to the normal to the plate 22.

FIG. 5 shows still another alternative embodiment. In this embodiment, the antenna wire denoted 284, corresponding to the radiating wire 84, is wound in a helix around an elastically deformable pylon 286. In the absence of stress, the pylon 286 extends perpendicular to the plate 22.

As before, the pylon 286 is connected to a mechanism 188 for moving its end, thereby allowing bending of the axis of the helix of the wire 284 by deforming the pylon 286. In this way, the mechanism 188 ensures an emission of the elementary wave produced by each wire in a direction angularly offset relative to the normal to the wall 22.

In the embodiment illustrated in FIG. 6, a focusing lens 288 is added to the arrangement described in FIG. 5. This lens is placed at the free end of the pylon 286.

According to an alternative of the embodiment described in FIG. 1, the wall 48 is eliminated and the antenna elements are then powered from the center. The mode converter 70 is supported by the inner surface of the wall 22.

1. A radiofrequency antenna comprising a chassis and an emission surface supporting a set of radiating antenna elements, each radiating in a unique emission direction, each antenna element being at least partially movable relative to the emission surface to modify its phase shift and comprising means for moving the antenna elements in a coordinated manner along said surface to form, from the elementary waves produced by the antenna elements, a coherent wave propagating in a direction that is angularly offset relative to the normal to the emission surface, the movement means comprising racks slidingly mounted relative to the emission surface and the emission wires being integral with drive pinions engaged with the racks, the movement means comprising a mechanism for synchronized movement of the racks,
wherein the synchronized movement mechanism includes a rotary control crown relative to the chassis and provided with control cams of the racks, the racks each being equipped with at least one cam follower cooperating with a cam, and a motor for rotating the crown.

2. The radiofrequency antenna according to claim 1, wherein the antenna elements are distributed by groups of antenna elements, the elements of a same group being present in a strip of the emission surface extending perpendicular to the projection of the emission direction on the surface, the antenna elements of a same group being positioned to produce elementary waves having a same phase shift relative to the waves produced by the antenna elements of another group.

3. The radiofrequency antenna according to claim 1, wherein the means for moving the antenna elements can position the antenna elements so that they each produce an elementary wave phase shifted by a phase shift [symbol] φ relative to the other antenna elements defined by: [symbol]
φ=2πh tgθ/λ
where θ is the incline angle of the emission direction relative to the normal to the emission surface, λ is the wavelength of the electromagnetic radiation, and h is the distance of the antenna element from a reference axis measured along the emission direction on the emission surface.

4. The radiofrequency antenna according to claim 1, wherein the antenna elements each include an emission wire rotatably mounted relative to the emission surface and the means for moving the antenna elements are capable of rotating the antenna elements.

5. The radiofrequency antenna according to claim 1, wherein the emission surface supporting the radiating antenna elements is rotary relative to the chassis, and in that it comprises means for rotating the emission surface.

6. The radiofrequency antenna according to claim 1, wherein the chassis delimits a closed vacuum space in which the antenna elements are contained, and in that it comprises force-reacting guide pins between the chassis and the emission surface.
